(19) United States
(12) Patent Application Publication
(10) Pub. No.: US 2017/0329914 A1
(43) Pub. Date: Nov. 16, 2017

(54) Predicting Personalized Cancer Metastasis Routes, Biological Mediators of Metastasis and Metastasis Blocking Therapies

(71) Applicant: International Business Machines Corporation, Armonk, NY (US)

(72) Inventors: Solomon Assefa, Ossining, NY (US); Geoffrey H. Siwo, Sandton (ZA); Gustavo A. Stolovitzky, Riverdale, NY (US)

(21) Appl. No.: 15/151,501

(22) Filed: May 11, 2016

(51) Int. Cl. G06F 19/00; G06F 19/18; G06F 19/24

(52) U.S. Cl. CPC G06F 19/345; G06F 19/324; G06F 19/18; G06F 19/24

(57) ABSTRACT

Embodiments of the present invention may provide the capability to predict the metastasis of cancer in a patient from one tissue to another. In an embodiment, a computer-implemented method for predicting metastasis may comprise receiving an indication of at least one disrupted gene of the cancer, traversing data representing a gene-to-gene or protein-to-protein interaction network specific for a type of the cancer type from a position of the received gene in the network to a position of at least one gene involved in metastasis for a tissue type, organ or body part, determining at least one shortest path in the network between the received gene and the at least one gene involved in metastasis for the tissue type, organ or body part, generating a prediction of metastasis to the tissue type based on the at least one determined path, and generating an output display indicating a likelihood of spread of cancer to the tissue type, organ or body part.

### BACKGROUND

The present invention relates to techniques for predicting the spread (metastasis) of cancer in a patient from one tissue to another.

Many methods for predicting the spread of cancer in a patient provide a prognostic prediction, such as whether the cancer is likely to spread to some other tissue and increase the risk of death or the expected survival of a patient. However, conventional methods cannot predict whether the cancer will spread to particular tissues or organs. Such conventional methods may rely on correlations (co-morbidity of cancers) such that cancers that tend to occur together in patients based on medical records are assumed to be more likely to spread in the same way.

However, such conventional approaches for predicting cancer prognosis or survival rates typically do not provide sufficient information that can be utilized to prevent the spread of the cancer to other tissues due to lack of knowledge of the molecular basis of metastasis. Likewise, existing approaches may assume that metastasis from one tissue to another does not vary from patient to patient. Further, existing approaches, as well those in development, may require many genes to be assayed to predict prognosis, which is expensive and would require substantial effort and expense in clinical validation for new diagnostics.

Accordingly, a need arises for techniques by which the metastasis of cancer in a patient from one tissue to another can be predicted that provide improved results, with reduced effort and expense.

### SUMMARY

Embodiments of the present invention may provide the capability to predict the metastasis of cancer in a patient from one tissue to another and provide improved results, with reduced effort and expense.

In an embodiment of the present invention, a computer-implemented method for predicting metastasis of a cancer may comprise receiving an indication of at least one disrupted gene of the cancer, querying data representing a gene-to-gene or protein-to-protein interaction network to determine the position of the received gene, wherein the data representing gene-to-gene or protein-to-protein interaction network comprises data representing genes or proteins as nodes of the network and functional or physical interactions between the genes or proteins as edges of the network, traversing the data representing the gene-to-gene or protein-to-protein interaction network specific for a type of the cancer from a position of the received gene in the network to a position of at least one gene involved in metastasis for at least one tissue type, organ, or body part, determining at least one shortest path in the network between the received gene and the at least one gene involved in metastasis for the tissue type, organ or body part, generating a prediction of metastasis to the tissue type based on the at least one determined path, and generating an output display indicating a likelihood of spread of cancer to the tissue type.

In an embodiment of the present invention, generating a prediction of metastasis to different tissue types may comprise recording genes in the shortest paths between the input gene and the plurality of genes involved in metastasis for the plurality of tissue types, organs, or body parts and ranking the recorded genes based on a predicted probability of metastasis to each of the plurality of tissue types, organs or body parts. Generating the prediction of metastasis to different tissue types may comprise determining a number of connections in each path between the input gene and the at least one gene involved in metastasis for each of the plurality of different tissue types and ranking the plurality of different tissue types based on the number of connections. Generating the prediction of metastasis to different tissue types may comprise determining a number of connections in each path between the input gene and the at least one gene involved in metastasis for each of the plurality of different tissue types and ranking the plurality of different tissue types based on statistical enrichment of each gene involved in metastasis among genes with direct connections to the input gene.

In an embodiment of the present invention, the method may further comprise determining at least one drug to treat the metastasis to at least one tissue type, organ, or body part. The at least one drug to treat the metastasis to at least one tissue type, organ or body part may be determined by determining at least one drug that targets at least one gene among the recorded genes in the shortest paths, determining at least one drug that affects at least one gene in the shortest path, determining at least one drug for which the efficacy of the drug or resistance to the drug is affected by the at least one gene or at least one shortest path, or determining at least one drug that interferes with expression of at least one gene in the shortest path.

In an embodiment of the present invention, the method may further comprise determining a likelihood that the received gene is a potential biomarker-specific metastasis associated gene by determining known metastasis genes that are second degree neighbors of at least one biomarker, determining known metastasis genes that are second degree neighbors of the received gene, determining a proportion of known metastasis genes that are also shared second degree neighbors of the biomarker and the received gene, determining a likelihood of observing a given proportion of shared second degree neighbors between the biomarker and the received gene in randomly sampled gene sets of the same size as sets of known metastasis genes, wherein the observed proportion is greater than the proportion of known metastasis genes that are shared second degree neighbors of the biomarker and the received gene, and determining a confidence that a given gene is a biomarker specific metastasis associated gene based on the determined likelihood. The method may be performed using at least one biomarker specific metastasis associated gene instead of at least one gene involved in metastasis for the tissue type, organ or body part.

In an embodiment of the present invention, a computer program product for predicting metastasis of a cancer may comprise a non-transitory computer readable storage having program instructions embodied therewith, the program instructions executable by a computer, to cause the computer to perform a method comprising receiving an indication of at least one disrupted gene of the cancer, querying data representing a gene-to-gene or protein-to-protein interaction network to determine the position of the received gene, wherein the data representing gene-to-gene or protein-to-protein interaction network comprises data representing genes or proteins as nodes of the network and functional or physical interactions between the genes or proteins as edges of the network, traversing the data representing the gene-to-gene or protein-to-protein interaction network specific for a type of the cancer from a position of the received gene in the network to a position of at least one gene involved in metastasis for at least one tissue type, organ, or body part, determining at least one shortest path in the network between the received gene and the at least one gene involved in metastasis for the tissue type, organ or body part, generating a prediction of metastasis to the tissue type based on the at least one determined path, and generating an output display indicating a likelihood of spread of cancer to the tissue type.

In an embodiment of the present invention, a system for predicting metastasis of a cancer may comprise a processor, memory accessible by the processor, and computer program instructions stored in the memory and executable by the processor to perform receiving an indication of at least one disrupted gene of the cancer, querying data representing a gene-to-gene or protein-to-protein interaction network to determine the position of the received gene, wherein the data representing gene-to-gene or protein-to-protein interaction network comprises data representing genes or proteins as nodes of the network and functional or physical interactions between the genes or proteins as edges of the network, traversing the data representing the gene-to-gene or protein-to-protein interaction network specific for a type of the cancer from a position of the received gene in the network to a position of at least one gene involved in metastasis for at least one tissue type, organ, or body part, determining at least one shortest path in the network between the received gene and the at least one gene involved in metastasis for the tissue type, organ or body part, generating a prediction of metastasis to the tissue type based on the at least one determined path, and generating an output display indicating a likelihood of spread of cancer to the tissue type.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of an analysis of gene-to-gene and/or protein-to-protein interaction pathways.

FIG. 2 is an exemplary diagram of an analysis of gene-to-gene and/or protein-to-protein interaction pathways.

FIG. 3 is an exemplary diagram of an analysis of gene-to-gene and/or protein-to-protein interaction pathways.

FIG. 4 is an exemplary diagram of an analysis of gene-to-gene and/or protein-to-protein interaction pathways.

FIG. 5 is an exemplary diagram of an analysis of gene-to-gene and/or protein-to-protein interaction pathways.

FIG. 6 is an exemplary flow diagram of a process for predicting metastasis of a cancer.

FIG. 7 is an exemplary flow diagram of a process for generating a ranked list of possible metastasis sites.

FIG. 8 is exemplary flow diagram of a process to predict potential metastasis inhibitors for the identified metastasis routes to each tissue.

FIG. 9 is an illustration of an example of the implementation of the present invention, applied to a particular mutated gene.

FIG. 10 is an exemplary flow diagram of a process for estimating the likelihood that a given gene or genes is a potential biomarker-specific metastasis associated gene (MAG).

FIG. 11 is an exemplary data flow diagram of the process shown in FIG. 10

FIG. 12 is an exemplary block diagram of a computer system in which processes involved in the embodiments described herein may be implemented.

### DETAILED DESCRIPTION

Embodiments of the present invention may provide the capability to predict the metastasis of cancer in a patient from one tissue, organ, or body part to another and provide improved results, with reduced effort and expense.

Certain cancers have a proclivity to spread to specific tissues. This process is non-random. Embodiments of the present invention may utilize the property that the progression of a cancer from its primary state to its metastasized state is non-random because the molecular networks of cancer biomarkers are related to those of genes mediating metastasis. For example, the shortest path in a molecular network of a cancer cell linking a dysregulated cancer gene of a patient to a set of known metastasis genes for a particular tissue may predict the most likely tissue to which the cancer may spread.

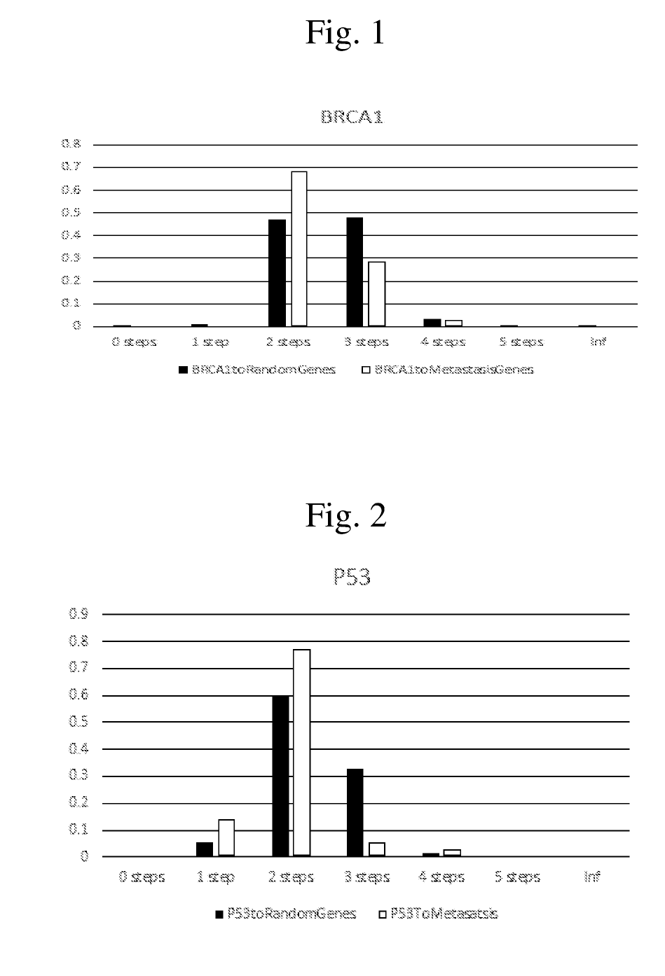

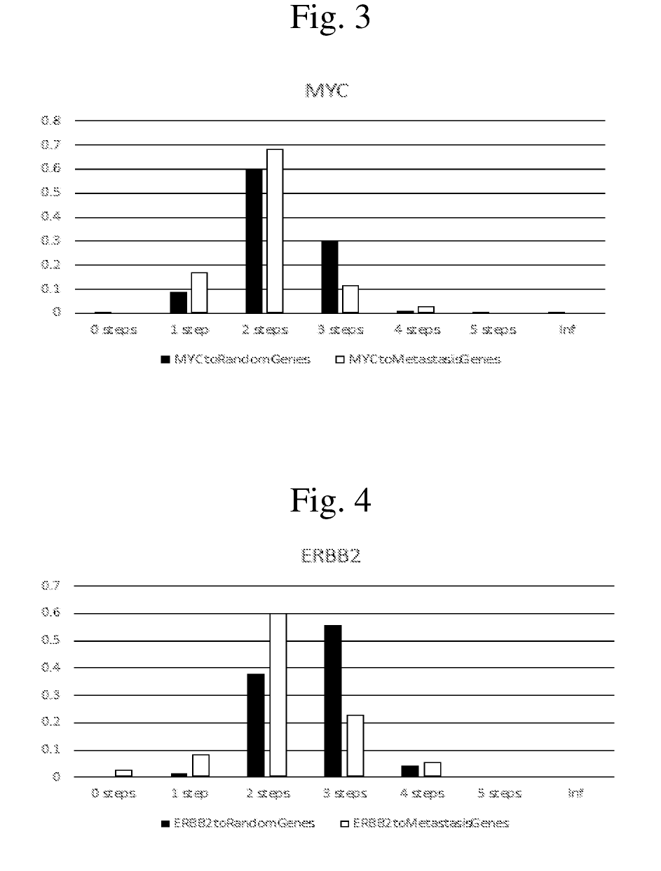

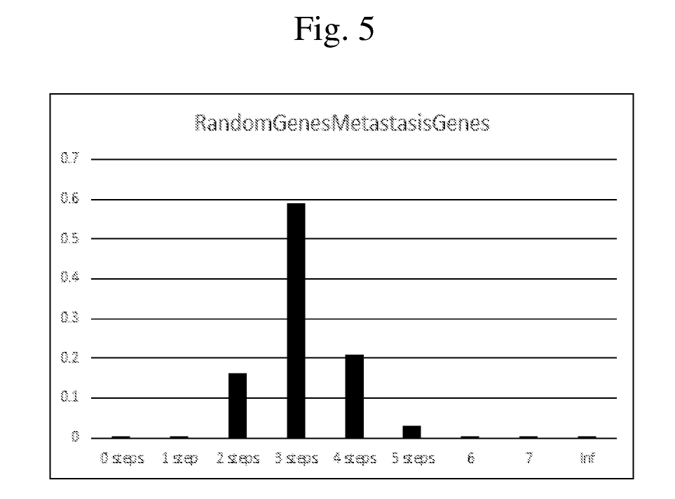

An example of the analysis of such pathways may be seen in FIGS. 1-5. In the analysis shown in FIGS. 1-5, a gene-to-gene and/or protein-to-protein interaction network may be constructed using gene expression profiles from the cancer cell line MCF7. The cancer biomarkers BRCA1 (FIG. 1), P53 (FIG. 2), MYC (FIG. 3), and ERBB2 (FIG. 4) are all a short path away from a set of known genes that mediate metastasis (metastasis genes), when compared to the pairwise distances between the biomarkers and randomly sampled genes (FIG. 5). This may also provide a mechanistic explanation for the role of the well-known cancer associated gene P53 in independently driving metastasis through its effect on metastasis associated genes.

Embodiments of the present invention may provide a way by which the spread of cancer may be blocked by targeting the genes mediating the spread. For example, if the genes predicted by the approach to be mediators of the spread of the cancer are also targets of particular drugs, then those particular corresponding drugs targeting the gene or its protein product may potentially be used to block metastasis. Likewise, embodiments of the present invention may provide personalized prediction of specific organs/tissues to which a cancer may spread in a given patient, thereby enabling early clinical screening or surgical removal of metastasized cancer cells from the patient. In addition, embodiments of the present invention may be used to provide information about the molecular basis of cancer metastasis. Further, embodiments of the present invention may utilize cancer biomarkers for which diagnostics are already approved, hence repurposing the diagnostics to predict metastasis and extensively reducing the timeline for development to market.

Embodiments of the present invention may identify hidden molecular connections between cancer causing genes or biomarkers and metastasis genes using a graph or molecular network that depicts relationships and interactions between genes in the cancer type. The metastasis genes may be sets of genes that have been previously shown experimentally to be associated with spread of cancer from one tissue to another and may be obtained from external sources, such as experimentation and professional and academic literature.

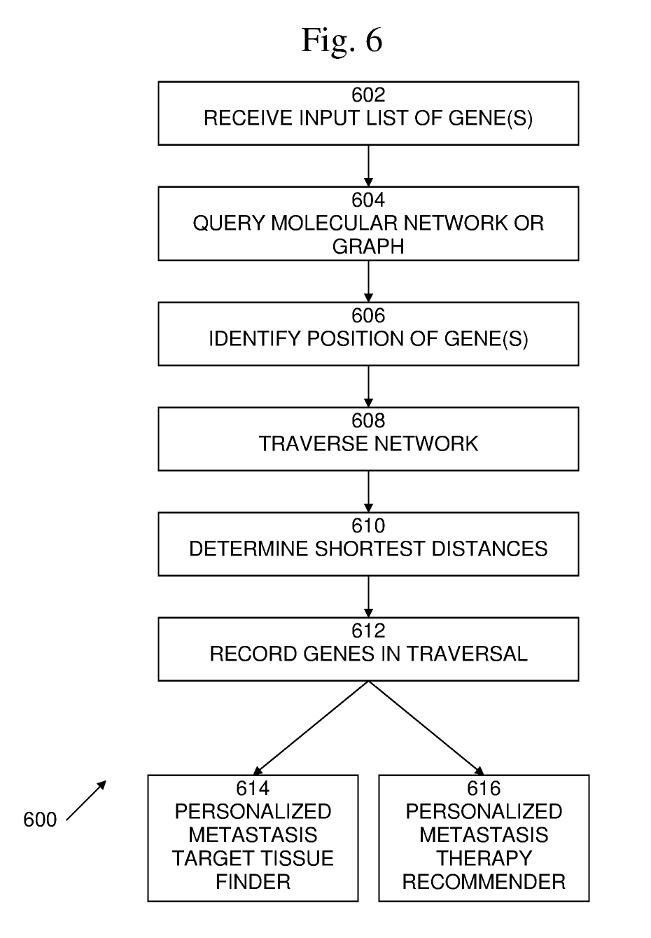

An example of a process 600, in accordance with the present invention, is shown in FIG. 6. Process 600 begins with 602, in which an input of one or more disrupted gene, such as mutated or dysregulated genes, in a cancer patient may be received. Such genes may include well known cancer biomarkers, such as BRCA1, P53, MYC, ERBB2, as well as others which may be currently known, or which may be discovered in the future. In addition, genes not considered as cancer biomarkers but that are disrupted, such as mutated or dysregulated, in a cancer patient may also be provided as input. Dysregulated genes or proteins may include genes that have altered expression or altered post-translational modification levels, such as phosphorylation, acetylation, or other modifications. These disrupted genes may be determined using one or more conventional methods, such as DNA/RNA sequencing, immunohistochemistry, ELISA, mass spectrometry, PCR, etc. It is to be noted that the present invention is not limited to currently known genes or gene determining techniques, but rather, contemplates using any and all genes that are known or that may be discovered using any gene determination technique.

At 604, the input gene or genes may then be used to query a molecular network or graph. The network or graph may be arranged so that the nodes are genes or proteins and the edges represent functional or physical interactions between the genes and/or proteins. The molecular network may be derived from the same cell type as that affected by the cancer in the given patient. For example, in the case of breast cancer, the molecular network may be constructed using gene expression data derived from breast cancer cell lines or patient derived cells, which may be from one or more patients. The molecular networks may be constructed through conventional methods or through newly developed methods. For example, gene expression data from breast cancer cell lines may be used to identify potential functional interactions by estimating the correlations between all pairs of genes using statistical measures of association such as Pearson or Spearman correlation, mutual information, etc. Alternatively, or in addition, the networks may be derived from experimental work, such as determination of protein-protein interactions using yeast-2-hybrid systems.

The molecular network may be queried using the input gene or genes using a process that may be referred to as Personalized Metastasis Molecular Route Finder (PMMRF). For example, at 606, the position or positions of the input gene or genes in the molecular network may be identified. From this position, at 608, the network may be traversed to locate the positions of a set of genes that are known to be involved in metastasis to specific tissues. Lists of such genes associated with metastasis to specific tissues may be obtained from experiments, from professional or academic literature or by other methods.

At 610, the shortest distances or path lengths from the input gene(s) to the each of the metastasis genes may be determined by counting the number of edges that must be visited in the shortest ‘walk’ from the location of the input gene in the molecular network to each of the metastasis genes. At 612, the genes (nodes) that are visited in the traversal of the network may be recorded. The genes lying in the shortest paths between the disrupted (mutated/dysregulated) input gene and the metastasis genes are potential candidates for inhibition of the metastatic process. These genes constitute what may be termed the Metastasis Molecular Route (MMR) and may be used as inputs to two additional processes described below: what may be termed the Personalized Metastasis Target Tissue Finder (PMTTF) and the Personalized Metastasis Therapy Recommender (PMTR).

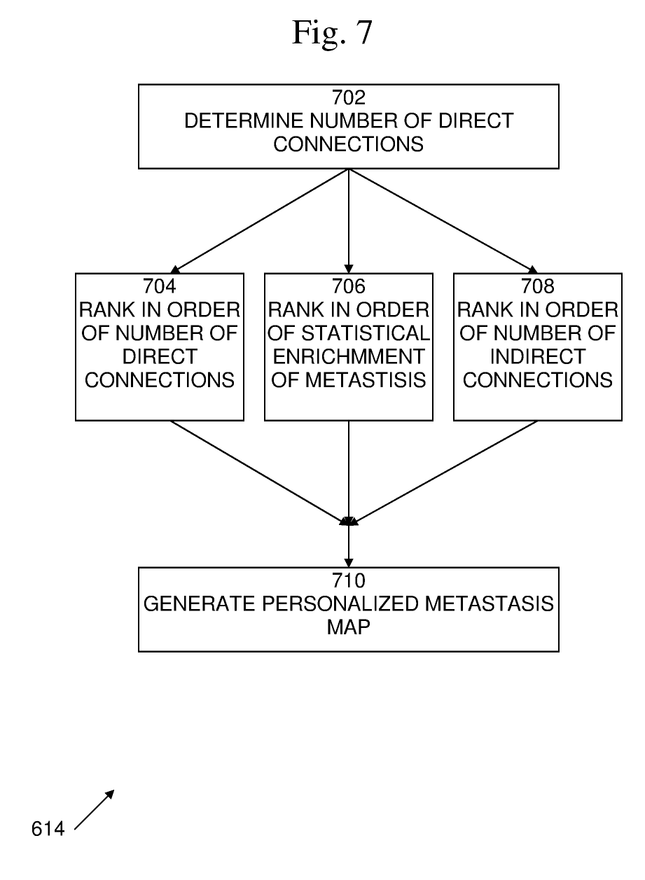

The process known as PMTTF 614 may be used to predict the most likely tissue or organ or body part to which the cancer might spread by providing a ranked list of possible metastasis sites. For example, a ranked list may be produced using a process 614 as shown in FIG. 7. At 702, for each tissue, the number of direct connections between the disrupted (mutated/dysregulated) input gene(s) and genes associated with metastasis to that tissue may be determined. At 704, the tissues may be ranked in order of the number of direct connections between its metastasis associated genes and the input gene(s). The tissue having the greatest number of such direct connections may be ranked first and considered as the most preferred metastasis site or as the first site at which the cancer might spread first. Alternatively, at 706, the tissues may be ranked based on the statistical enrichment of their metastasis associated genes among the list of genes with direct connections to the input gene(s). Statistical enrichment may be determined by standard statistical procedures such as the hypergeometric test or by determining the probability of observing direct connections between the input gene(s) and a number, such as 1000, random samples of gene lists of the same length as that of the metastasis genes. In the absence of direct connections between the input gene(s) and genes associated with metastasis to any tissue, at 708, tissues may be ranked based on the number of indirect connections separating the input gene(s) from the metastasis genes to a given tissue, where the relevant number is the shortest observed distance (edges) separation distance. As a further example, in addition, edges in the path connecting the gene of interest to those mediating metastasis to a particular tissue may be weighted, and the target tissue likelihood may be the sum of weights along the path. Such weighting factors may include the distance of each edge from the gene of interest, the significance of the intermediate nodes, etc.

At 710, the output of PMTTF may also be represented as a Personalized Metastasis Map (PMM) for a patient showing the likely spread of cancer to other tissues in the patient. The PMM may be used by clinicians to guide further clinical examination of patients for the presence of metastasized cancer in the predicted tissues for surgical or other intervention.

To recommend target therapy, PMTR may be applied in one or more of the following ways. First, genes identified in the shortest paths to metastasis genes may be examined to determine whether they include drug targets. Such examination may be performed using prior knowledge in literature, drug databases, and clinical trials data.

Secondly, the pathways enriched in the Metastasis Molecular Route (MMR) may be identified and then targeted by drugs known to affect such pathways or drugs whose efficacy or resistance is affected by the genes or pathways. The enrichment of specific biological pathways in the MMR may be determined using approaches available in literature such as Gene Set Enrichment Analysis (GSEA) or Gene Ontology (GO) enrichment analysis. Alternatively, pathways represented by genes in the MMR, irrespective of their enrichment status, may be identified by matching the genes against pathway databases, such as, but not limited to, the Kyoto Encyclopedia of Genes and Genomes (KEGG). The identified pathways may then be matched against drug databases to find drugs that affect such pathways.

Third, therapeutics inhibiting metastasis may be identified by finding agents (drugs or small molecules) that interfere with the expression of one or more of the genes in the MMR of a patient, with priority given to agents that affect multiple genes in the MMR. Such agents may be predicted by querying large compendia of gene expression responses to perturbations of cells with small molecules, drugs or genetic perturbations or small interfering RNAs (siRNAs). Examples of such compendia may include, but are not limited to, the Connectivity Map (CMap) database and the Library of Integrated Network-Based Cellular Networks (LILACS).

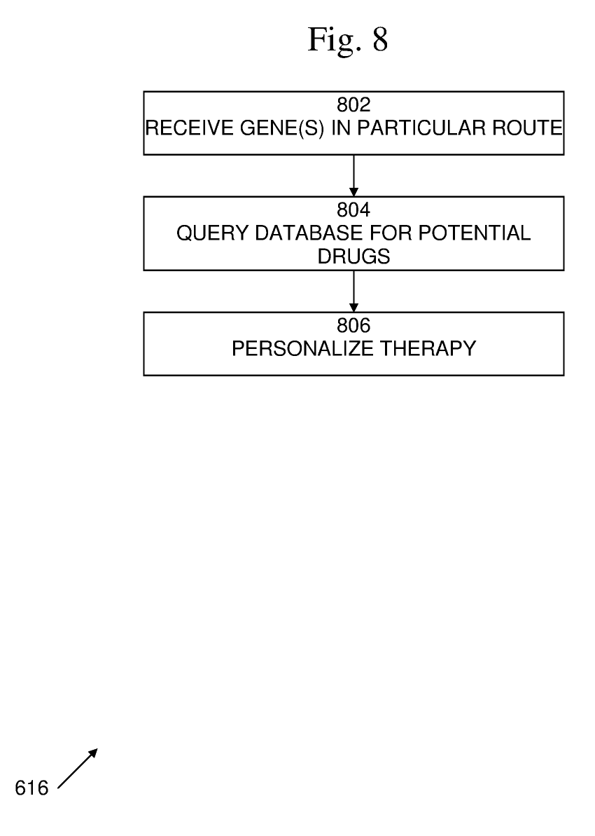

The process known as PMTR 616 may be used to predict potential metastasis inhibitors for the identified metastasis routes to each tissue using a process 616 as shown in FIG. 8. At 802, the genes identified as mediating one or more particular metastasis routes determined at 612 in FIG. 3 may be received. At 804, one or more databases may be queried for potential drugs that affect the received genes. Since gene(s) input at 602 of FIG. 6 may not regulate all genes identified as mediating one or more particular metastasis routes in all cancer tissues, at 806, cancer tissue specific networks may be used to personalize metastasis therapy for mutated cancers, depending on the tissue source of the cancer as well as whether or not the cancer exhibits disruption of the function of the input gene(s). Some genes may not have known inhibitors or may be linked to drug resistance to. This may inform selection of therapies against cancer metastasis related to the input gene(s) since they influence resistance. Thus, PMTR could also help select therapy to mitigate anti-cancer drug resistance.

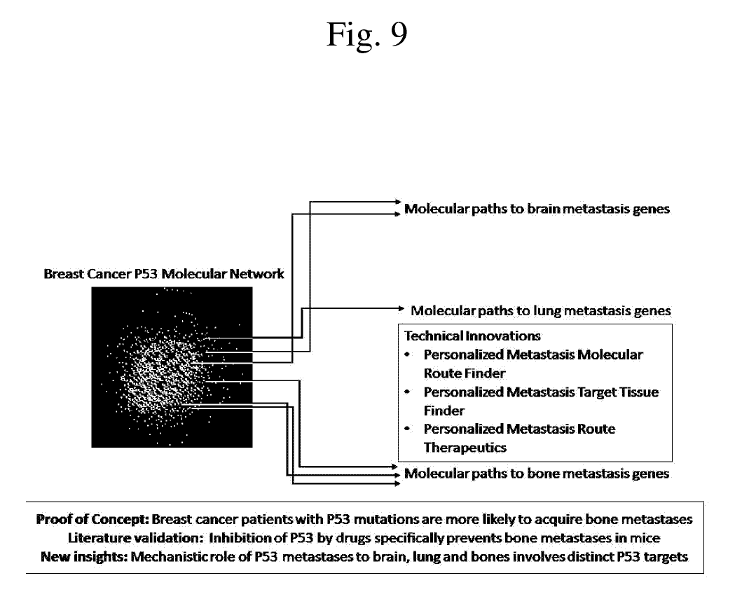

As a specific example of the implementation of the invention, the approach was applied to predict the metastasis of breast cancer with mutated P53 (the input gene, as at 602, shown in FIG. 6). This example is illustrated in FIG. 9. In this case, the molecular network was obtained using gene expression data of 448 breast cancer cell lines (MCF7 cell line) exposed to a wide variety of drugs in the CMap2 database. The network is publicly available and was downloaded from http://wiki.c2b2.columbia.edu/califanolab/index.php/Interactomes.

Lists of experimentally validated genes associated with metastasis to the brain, lung, and bones may be obtained, for example, from sources such as Brinton L T, Brentnall T A, Smith J A, Kelly K A. (2012). Metastatic biomarker discovery through proteomics. Cancer Genomics Proteomics. 9(6):345-55. Review, Bos P D, Zhang X H, Nadal C, Shu W, Gomis R R, Nguyen D X, Minn A J, van de Vijver M J, Gerald W L, Foekens J A, Massague J. (2009). Genes that mediate breast cancer metastasis to the brain. Nature. 459(7249):1005-9. doi: 10.1038/nature08021. Epub 2009 May 6, Minn A J, Gupta G P, Siegel P M, Bos P D, Shu W, Giri D D, Viale A, Olshen A B, Gerald W L, Massague J. (2005). Genes that mediate breast cancer metastasis to lung. Nature. 436(7050):518-24, and Kang Y, Siegel P M, Shu W, Drobnjak M, Kakonen S M, Cordón-Cardo C, Guise T A, Massague J. (2003). A multigenic program mediating breast cancer metastasis to bone. Cancer Cell. 3(6):537-49, Hoshino A, Costa-Silva B, Shen T L, Rodrigues G, Hashimoto A, Tesic Mark M, Molina H, Kohsaka S, Di Giannatale A, Ceder S, Singh S, Williams C, Soplop N, Uryu K, Pharmer L, King T, Bojmar L, Davies A E, Ararso Y, Zhang T, Zhang H, Hernandez J, Weiss J M, Dumont-Cole V D, Kramer K, Wexler L H, Narendran A, Schwartz G K, Healey J H, Sandstrom P, Labori K J, Kure E H, Grandgenett P M, Hollingsworth M A, de Sousa M, Kaur S, Jain M, Mallya K, Batra S K, Jarnagin W R, Brady M S, Fodstad O, Muller V, Pantel K, Minn A J, Bissell M J, Garcia B A, Kang Y, Rajasekhar V K, Ghajar C M, Matei I, Peinado H, Bromberg J, Lyden D. (2015). Tumour exosome integrins determine organotropic metastasis. Nature. 527(7578):329-35. doi: 10.1038/nature15756. Epub 2015 Oct. 28, Barney L E, Dandley E C, Jansen L E, Reich N G, Mercurio A M, Peyton S R (2015). A cell-ECM screening method to predict breast cancer metastasis. Integr Biol (Camb). 2:198-212. doi: 10.1039/c4ib00218k. respectively. A model of breast cancer metastasis routes was then derived using P53 as the input (mutant/dysregulated gene) with a goal of predicting the preferred metastasis routes of breast cancer cells with disrupted P53 function.

In this example, PMMRF was then applied as follows. First, as at 606, the location of P53 in the MCF7 breast cancer molecular network was identified. From this location, as at 608 and 610, the shortest paths between P53 and each of the genes associated with brain, lung and bone metastasis was determined, as at 612. In this analysis, as at 702, shown in FIG. 7, only direct paths between P53 and metastasis genes were determined, for example, paths with a length equal to 1 and having only a single edge connecting P53 to a metastasis gene. The direct metastasis routes (MMR) for P53 to bone metastasis routes involved 3 genes—DUSP1, FYN and GTSE1. Each of these genes associated with bone metastases are directly connected to P53 in the molecular network.

In this example, for brain metastasis genes, the direct connections to P53 are LAMA4 and PTGS2. For lung metastasis genes, there is only a single direct connection to P53—the gene PTGS2, which is also a brain metastasis gene. Based on these results, the likelihood of metastasis to bone is ranked first, as at 704, because P53 has the largest number of direct connections to bone metastasis genes in the MCF7 breast cancer network. Metastasis to the brain is ranked second and metastasis to the lungs is ranked last. For example, previous studies show that increased expression of P53 by drugs such as statins can be used to block cancer metastasis to bones (Mandal C C, Ghosh-Choudhury N, Yoneda T, Choudhury G G, Ghosh-Choudhury N. (2011). Simvastatin prevents skeletal metastasis of breast cancer by an antagonistic interplay between p53 and CD44. J Biol Chem. 286(13):11314-27. doi: 10.1074/jbc.M110.193714. Epub 2011 Jan. 3).

In this example, to predict potential metastasis inhibitors for the identified metastasis routes to each tissue, the therapy recommender PMTR 216 was applied as follows. As at 804 of FIG. 8, using the received genes (as at 802) identified as mediating P53 associated bone metastasis we queried the PubMed literature database and Drug Bank for potential drugs that affect DUSP1, FYN or GTSE1. The FYN gene encodes an Src family kinase that plays important roles in cell growth, osteoclast activation, and bone resorption, processes that influence cancer metastasis to bones. The anti-cancer drugs dasatanib is known to inhibit this kinase family including FYN, predicting that P53 dependent breast cancer metastasis to bones may be targeted using this drug. Consistent with this, dasatanib is currently in an ongoing Phase I/II trial for the treatment of breast cancer metastasis to bones (https://clinicaltrials.gov/show/NCT00566618). For example, FYN can be targeted by AZD0530 (saracanitib) which has been shown to inhibit human osteoclasts, hence is a potential candidate drug for blocking P53-mediated breast to bone metastasis (de Vries T J I, Mullender M G, van Duin M A, Semeins C M, James N, Green T P, Everts V, Klein-Nulend J. (2009). The Src inhibitor AZD0530 reversibly inhibits the formation and activity of human osteoclasts. Mol Cancer Res. 7(4):476-88. doi: 10.1158/1541-7786.MCR-08-0219).

In this example, since P53 may not regulate FYN in all cancer tissues, as at 806, cancer tissue specific networks can be used to personalize metastasis therapy for P53 mutated cancers, depending on the tissue source of the cancer as well as whether or not the cancer exhibits disruption of P53 function. DUSP1 and GTSE1 do not have known inhibitors. For example, in addition to both of these genes being associated with breast to bone metastasis, they have also been linked with drug resistance to gefitinib (Lin Y C, Lin Y C, Shih J Y, Huang W J, Chao S W, Chang Y L, Chen C C. (2015). DUSP1 expression induced by HDAC1 inhibition mediates gefitinib sensitivity in non-small cell lung cancers. Clin Cancer Res. 21(2):428-38. doi: 10.1158/1078-0432.CCR-14-1150) and cisplatin (Subhash V V, Tan S H, Tan W L, Yeo M S, Xie C, Wong F Y, Kiat Z Y, Lim R, Yong W P. (2015). GTSE1 expression represses apoptotic signaling and confers cisplatin resistance in gastric cancer cells. BMC Cancer. 15:550. doi: 10.1186/s12885-015-1550-0), respectively. This may inform selection of these therapies against P53 disrupted breast cancer metastasis to bones since they influence resistance. For example, the association between P53 and these drug resistance genes could partly account for the observed P53 associated resistance to cisplatin (Reles A, Wen W H, Schmider A, Gee C, Runnebaum I B, Kilian U, Jones L A, El-Naggar A, Minguillon C, Schonborn I, Reich O, Kreienberg R, Lichtenegger W, Press M F. (2001). Correlation of p53 mutations with resistance to platinum-based chemotherapy and shortened survival in ovarian cancer. Clin Cancer Res. 7(10):2984-97) and gefitinib (Rho J K I, Choi Y J, Ryoo B Y, Na I I, Yang S H, Kim C H, Lee J C. (2007). p53 enhances gefitinib-induced growth inhibition and apoptosis by regulation of Fas in non-small cell lung cancer. Cancer Res. 67(3):1163-9). For example, this observation could also underlie the recently reported association between many cancer biomarkers and cancer drug resistance, even in cases there the cancer biomarker is not a direct target of specific anti-cancer agents (Garnett M J, Edelman E J, Heidorn S J, Greenman C D, Dastur A, Lau K W, Greninger P, Thompson I R, Luo X, Soares J, Liu Q, Iorio F, Surdez D, Chen L, Milano R J, Bignell G R, Tam A T, Davies H, Stevenson J A, Barthorpe S, Lutz S R, Kogera F, Lawrence K, McLaren-Douglas A, Mitropoulos X, Mironenko T, Thi H, Richardson L, Zhou W, Jewitt F, Zhang T, O'Brien P, Boisvert J L, Price S, Hur W, Yang W, Deng X, Butler A, Choi H G, Chang J W, Baselga J, Stamenkovic I, Engelman J A, Sharma S V, Delattre O, Saez-Rodriguez J, Gray N S, Settleman J, Futreal P A, Haber D A, Stratton M R, Ramaswamy S, McDermott U, Benes C H. (2012). Systematic identification of genomic markers of drug sensitivity in cancer cells. Nature. 483(7391):570-5. doi: 10.1038/nature11005). Thus, PMTR could also help select therapy to mitigate anti-cancer drug resistance.

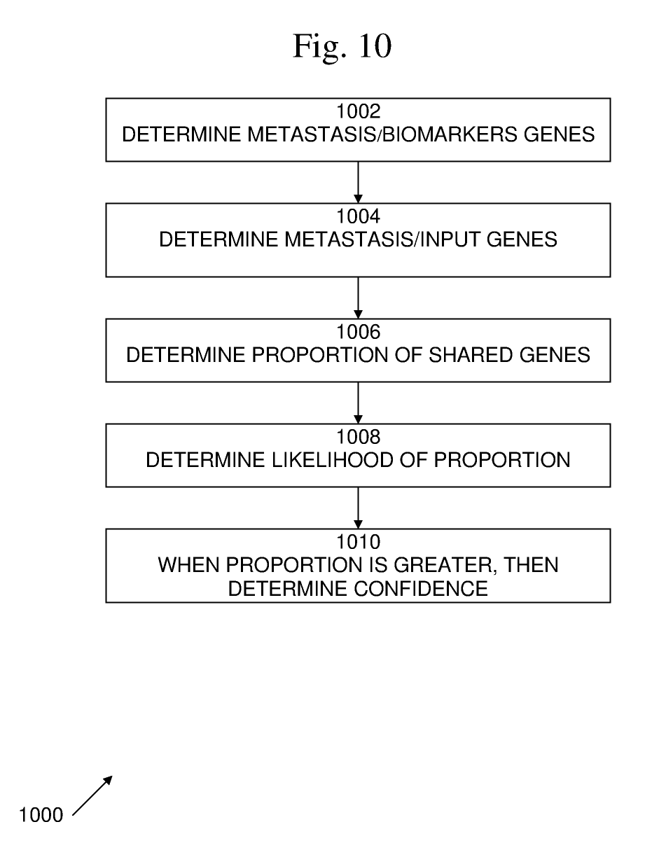

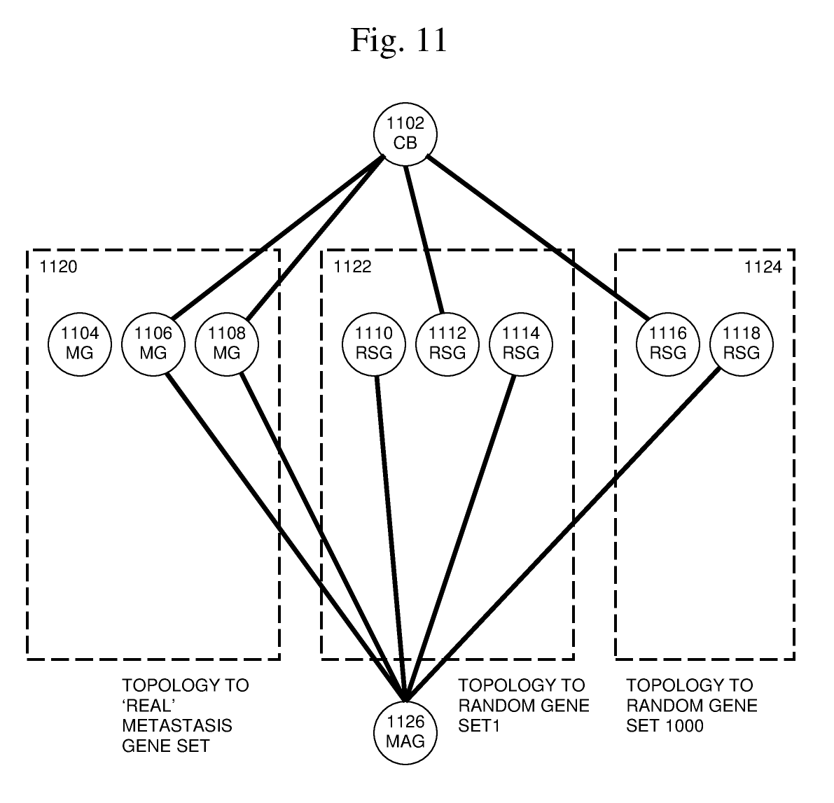

An exemplary process 1000 for estimating the likelihood that a given gene or genes is a potential biomarker-specific metastasis associated gene (MAG) is illustrated in FIG. 10. It is best viewed in conjunction with FIG. 11, which is an exemplary data flow diagram of the process shown in FIG. 10. Process 1000 begins with 1002, in which known metastasis genes 1104-1108 that are second degree neighbors of one or more specified cancer biomarkers 1102 may be determined. At 1004, known metastasis genes that are second degree neighbors of the input gene or each of the input genes may be determined, for example, as described above. At 1006, the proportion of known metastasis genes that also share second degree neighbors with the specified biomarker and the input gene may be determined, as at 1120. At 1008, the likelihood of observing a given proportion of shared second degree neighbors between the biomarker and the input gene in randomly sampled gene sets of the same size as known metastasis genes may be determined, as at 1122 and 1124. At 1010, when the determined proportion of shared second degree neighbors between the biomarker and the input gene in the randomly sampled gene sets 1122, 1124 is greater than the proportion of known metastasis genes that are shared second degree neighbors of the biomarker and the input gene 1120, then the confidence that a given gene is a biomarker-specific MAG may be determined based on this likelihood.

Further, once one or more biomarker specific MAGs has been determined, the input genes on the list received in step 602, shown in FIG. 6, that are involved in metastasis to specific tissues, organs or body parts may be replaced in part or entirety by the biomarker specific MAGs so determined.

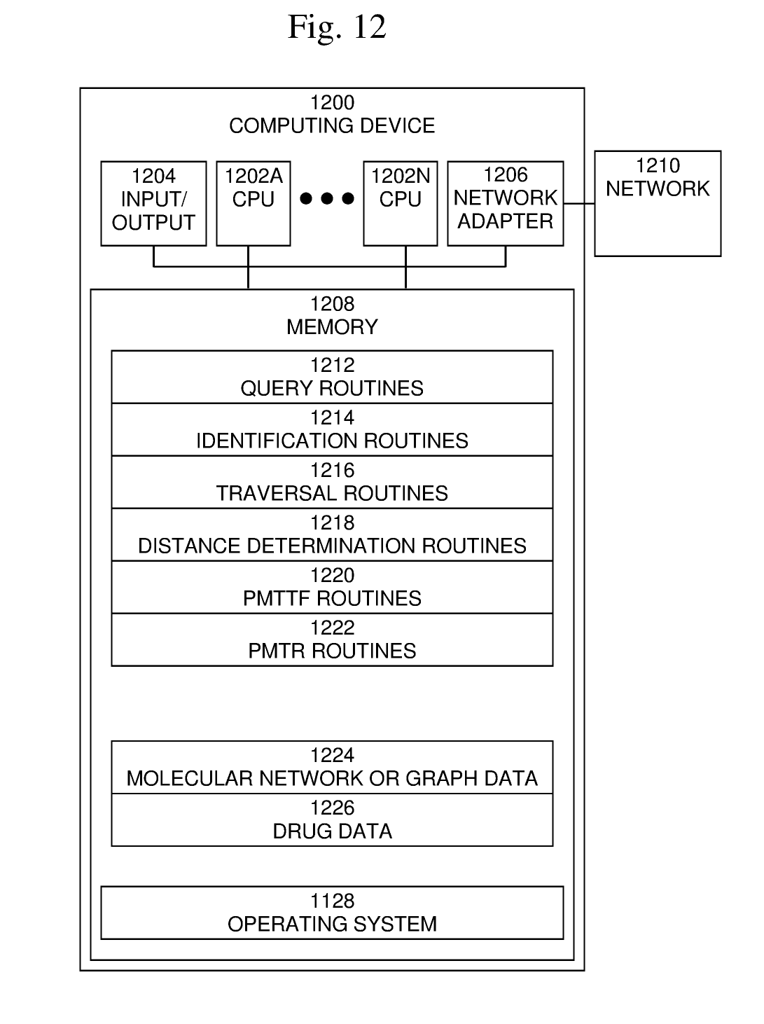

An exemplary block diagram of a computer system 1200, in which processes involved in the embodiments described herein may be implemented, is shown in FIG. 12. Computer system 1200 is typically a programmed general-purpose computer system, such as an embedded processor, system on a chip, personal computer, workstation, server system, and minicomputer or mainframe computer. Computer system 1200 may include one or more processors (CPUs) 1202A-1202N, input/output circuitry 1204, network adapter 1206, and memory 1208. CPUs 1202A-1202N execute program instructions in order to carry out the functions of the present invention. Typically, CPUs 1202A-1202N are one or more microprocessors, such as an INTEL PENTIUM® processor. FIG. 12 illustrates an embodiment in which computer system 1200 is implemented as a single multi-processor computer system, in which multiple processors 1202A-1202N share system resources, such as memory 1208, input/output circuitry 1204, and network adapter 1206. However, the present invention also contemplates embodiments in which computer system 1200 is implemented as a plurality of networked computer systems, which may be single-processor computer systems, multi-processor computer systems, or a mix thereof.

Input/output circuitry 1204 provides the capability to input data to, or output data from, computer system 1200. For example, input/output circuitry may include input devices, such as keyboards, mice, touchpads, trackballs, scanners, etc., output devices, such as video adapters, monitors, printers, etc., and input/output devices, such as, modems, etc. Network adapter 1206 interfaces device 1200 with a network 1210. Network 1210 may be any public or proprietary LAN or WAN, including, but not limited to the Internet.

Memory 1208 stores program instructions that are executed by, and data that are used and processed by, CPU 1202 to perform the functions of computer system 1200. Memory 1208 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 1208 may vary depending upon the function that computer system 1200 is programmed to perform. For example, as shown in FIG. 1, computer systems may perform a variety of roles in the system, method, and computer program product described herein. For example, computer systems may perform one or more roles as end devices, gateways/base stations, application provider servers, and network servers. In the example shown in FIG. 12, exemplary memory contents are shown representing routines and data for all of these roles. However, one of skill in the art would recognize that these routines, along with the memory contents related to those routines, may not typically be included on one system or device, but rather are typically distributed among a plurality of systems or devices, based on well-known engineering considerations. The present invention contemplates any and all such arrangements.

In the example shown in FIG. 12, memory 1208 may include query routines 1212, identification routines 1214, traversal routines 1216, distance determination routines 1218, PMTTF routines 1220, PMTR routines 1222, molecular network or graph data 1224, drug data 1226, and operating system 1228. For example, query routines 1212 may include routines to query molecular network or graph data 1224 using the input gene(s). Identification routines 1214 may include routines to identify the position or positions of the input gene or genes in the molecular network. Traversal routines 1216 may include routines and data to locate the positions of a set of genes that are known to be involved in metastasis to specific tissues. Distance determination routines 1218 may include routines to determine the shortest distances or path lengths from the input gene(s) to the each of the metastasis genes. PMTTF routines 1220 may include routines to predict the most likely tissue or body part to which the cancer might spread. PMTR routines 1222 may include routines recommend target therapy using drug data 1226. Operating system 1228 provides overall system functionality.

As shown in FIG. 12, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for predicting metastasis of a cancer comprising:
receiving an indication of at least one disrupted gene of the cancer;
querying data representing a gene-to-gene or protein-to-protein interaction network to determine the position of the received gene, wherein the data representing gene-to-gene or protein-to-protein interaction network comprises data representing genes or proteins as nodes of the network and functional or physical interactions between the genes or proteins as edges of the network;
traversing the data representing the gene-to-gene or protein-to-protein interaction network specific for a type of the cancer from a position of the received gene in the network to a position of at least one gene involved in metastasis for at least one tissue type, organ, or body part;
determining at least one shortest path in the network between the received gene and the at least one gene involved in metastasis for the tissue type, organ or body part;
generating a prediction of metastasis to the tissue type, organ or body part based on the at least one determined path; and
generating an output display indicating a likelihood of spread of cancer to the tissue type, organ or body part.

2. The method of claim 1, wherein generating a prediction of metastasis to different tissue types, organs or body parts comprises:
recording genes in the shortest paths between the input gene and the plurality of genes involved in metastasis for the plurality of tissue types, organs, or body parts; and
ranking the recorded genes based on a predicted probability of metastasis to each of the plurality of tissue types, organs, or body parts.

3. The method of claim 1, wherein generating the prediction of metastasis to different tissue types, organs or body parts comprises:
determining a number of connections in each path between the input gene and the at least one gene involved in metastasis for each of the plurality of different tissue types, organs or body parts; and
ranking the plurality of different tissue types based on the number of connections.

4. The method of claim 1, wherein generating the prediction of metastasis to different tissue types comprises:
determining a number of connections in each path between the input gene and the at least one gene involved in metastasis for each of the plurality of different tissue types; and
ranking the plurality of different tissue types, organs or body parts based on statistical enrichment of each gene involved in metastasis among genes with direct connections to the input gene.

5. The method of claim 1, further comprising:
determining at least one drug to treat the metastasis to at least one tissue type, organ, or body part.

6. The method of claim 4, wherein the at least one drug to treat the metastasis to at least one tissue type, organ, or body part is determined by:
determining at least one drug that targets at least one gene among the recorded genes in the shortest paths;
determining at least one drug that affects at least one gene in the shortest path;
determining at least one drug for which the efficacy of the drug or resistance to the drug is affected by the at least one gene or at least one shortest path; or
determining at least one drug that interferes with expression of at least one gene in the shortest path.

7. The method of claim 1, further comprising determining a likelihood that the received gene is a potential biomarker-specific metastasis associated gene by:
determining known metastasis genes that are second degree neighbors of at least one biomarker;
determining known metastasis genes that are second degree neighbors of the received gene;
determining a proportion of known metastasis genes that are also shared second degree neighbors of the biomarker and the received gene;
determining a likelihood of observing a given proportion of shared second degree neighbors between the biomarker and the received gene in randomly sampled gene sets of the same size as sets of known metastasis genes, wherein the observed proportion is greater than the proportion of known metastasis genes that are shared second degree neighbors of the biomarker and the received gene; and
determining a confidence that a given gene is a biomarker specific metastasis associated gene based on the determined likelihood.

8. The method of claim 6, wherein the method is performed using at least one biomarker specific metastasis associated gene instead of at least one at least one gene involved in metastasis for the tissue type, organ or body part.

9. A computer program product for predicting metastasis of a cancer, the computer program product comprising a non-transitory computer readable storage having program instructions embodied therewith, the program instructions executable by a computer, to cause the computer to perform a method comprising:
receiving an indication of at least one disrupted gene of the cancer;
querying data representing a gene-to-gene or protein-to-protein interaction network to determine the position of the received gene, wherein the data representing gene-to-gene or protein-to-protein interaction network comprises data representing genes or proteins as nodes of the network and functional or physical interactions between the genes or proteins as edges of the network;
traversing the data representing the gene-to-gene or protein-to-protein interaction network specific for a type of the cancer from a position of the received gene in the network to a position of at least one gene involved in metastasis for at least one tissue type, organ, or body part;
determining at least one shortest path in the network between the received gene and the at least one gene involved in metastasis for the tissue type, organ or body part;
generating a prediction of metastasis to the tissue type based on the at least one determined path; and
generating an output display indicating a likelihood of spread of cancer to the tissue type.

10. The computer program product of claim 9, wherein generating a prediction of metastasis to different tissue types comprises:
recording genes in the shortest paths between the input gene and the plurality of genes involved in metastasis for the plurality of tissue types, organs, or body parts; and
ranking the recorded genes based on a predicted probability of metastasis to each of the plurality of tissue types, organs, or body parts.

11. The computer program product of claim 9, wherein generating the prediction of metastasis to different tissue types comprises:
determining a number of connections in each path between the input gene and the at least one gene involved in metastasis for each of the plurality of different tissue types; and
ranking the plurality of different tissue types based on the number of connections.

12. The computer program product of claim 9, wherein generating the prediction of metastasis to different tissue types comprises:
determining a number of connections in each path between the input gene and the at least one gene involved in metastasis for each of the plurality of different tissue types; and
ranking the plurality of different tissue types based on statistical enrichment of each gene involved in metastasis among genes with direct connections to the input gene.

13. The computer program product of claim 9, further comprising program instructions for:
determining at least one drug to treat the metastasis to at least one tissue type, organ, or body part.

14. The computer program product of claim 13, wherein the at least one drug to treat the metastasis to at least one tissue type, organ, or body part is determined by:
determining at least one drug that targets at least one gene among the recorded genes in the shortest paths;
determining at least one drug that affects at least one gene in the shortest path;
determining at least one drug for which the efficacy of the drug or resistance to the drug is affected by the at least one gene or at least one shortest path; or
determining at least one drug that interferes with expression of at least one gene in the shortest path.

15. The computer program product of claim 9, further comprising program instructions for determining a likelihood that the received gene is a potential biomarker-specific metastasis associated gene by:
determining known metastasis genes that are second degree neighbors of at least one biomarker;
determining known metastasis genes that are second degree neighbors of the received gene;
determining a proportion of known metastasis genes that are also shared second degree neighbors of the biomarker and the received gene;
determining a likelihood of observing a given proportion of shared second degree neighbors between the biomarker and the received gene in randomly sampled gene sets of the same size as sets of known metastasis genes, wherein the observed proportion is greater than the proportion of known metastasis genes that are shared second degree neighbors of the biomarker and the received gene; and
determining a confidence that a given gene is a biomarker specific metastasis associated gene based on the determined likelihood.

16. The computer program product of claim 15, further comprising program instructions for using at least one biomarker specific metastasis associated gene instead of at least one gene involved in metastasis for the tissue type, organ or body part.

17. A system for predicting metastasis of a cancer, the system comprising a processor, memory accessible by the processor, and computer program instructions stored in the memory and executable by the processor to perform:
receiving an indication of at least one disrupted gene of the cancer;
querying data representing a gene-to-gene or protein-to-protein interaction network to determine the position of the received gene, wherein the data representing gene-to-gene or protein-to-protein interaction network comprises data representing genes or proteins as nodes of the network and functional or physical interactions between the genes or proteins as edges of the network;
traversing the data representing the gene-to-gene or protein-to-protein interaction network specific for a type of the cancer from a position of the received gene in the network to a position of at least one gene involved in metastasis for at least one tissue type, organ, or body part;
determining at least one shortest path in the network between the received gene and the at least one gene involved in metastasis for the tissue type, organ or body part;
generating a prediction of metastasis to the tissue type based on the at least one determined path; and
generating an output display indicating a likelihood of spread of cancer to the tissue type.

18. The system of claim 19, wherein generating a prediction of metastasis to different tissue types comprises:
recording genes in the shortest paths between the input gene and the plurality of genes involved in metastasis for the plurality of tissue types, organs, or body parts; and
ranking the recorded genes based on a predicted probability of metastasis to each of the plurality of tissue types, organs, or body parts.

19. The system of claim 17, wherein generating the prediction of metastasis to different tissue types comprises:
determining a number of connections in each path between the input gene and the at least one gene involved in metastasis for each of the plurality of different tissue types; and
ranking the plurality of different tissue types based on the number of connections.

20. The system of claim 17, wherein generating the prediction of metastasis to different tissue types comprises:
determining a number of connections in each path between the input gene and the at least one gene involved in metastasis for each of the plurality of different tissue types; and
ranking the plurality of different tissue types based on statistical enrichment of each gene involved in metastasis among genes with direct connections to the input gene.

21. The system of claim 17, further comprising computer program instructions for:
determining at least one drug to treat the metastasis to at least one tissue type, organ, or body part.

22. The system of claim 21, wherein the at least one drug to treat the metastasis to at least one tissue type, organ, or body part is determined by:
determining at least one drug that targets at least one gene among the recorded genes in the shortest paths;
determining at least one drug that affects at least one gene in the shortest path;
determining at least one drug for which the efficacy of the drug or resistance to the drug is affected by the at least one gene or at least one shortest path; or
determining at least one drug that interferes with expression of at least one gene in the shortest path.

23. The system of claim 17, further comprising computer program instructions for determining a likelihood that the received gene is a potential biomarker-specific metastasis associated gene by:
determining known metastasis genes that are second degree neighbors of at least one biomarker;
determining known metastasis genes that are second degree neighbors of the received gene;
determining a proportion of known metastasis genes that are also shared second degree neighbors of the biomarker and the received gene;
determining a likelihood of observing a given proportion of shared second degree neighbors between the biomarker and the received gene in randomly sampled gene sets of the same size as sets of known metastasis genes, wherein the observed proportion is greater than the proportion of known metastasis genes that are shared second degree neighbors of the biomarker and the received gene; and
determining a confidence that a given gene is a biomarker specific metastasis associated gene based on the determined likelihood.

24. The system of claim 23, further comprising computer program instructions for using at least one biomarker specific metastasis associated gene instead of at least one at least one gene involved in metastasis for the tissue type, organ or body part.
